(19) United States
(12) Patent Application Publication
(10) Pub. No.: US 2018/0278109 A1
(43) Pub. Date: Sep. 27, 2018

(54) ROTARY ELECTRIC MACHINE

(71) Applicant: EXEDY CORPORATION, Neyagawa-shi, Osaka (JP)

(72) Inventor: Kousuke MURATA, Neyagawa-shi, Osaka (JP)

(21) Appl. No.: 15/758,290

(22) PCT Filed: Oct. 21, 2016
(86) PCT No.: PCT/JP2016/081302

§ 371 Date: Mar. 7, 2018

(30) Foreign Application Priority Data
Nov. 13, 2015 (JP) 2015-222735

(51) Int. Cl. H02K 3/24; H02K 5/20; H02K 9/19

(52) U.S. Cl. CPC H02K 3/24; H02K 9/19; H02K 5/20

(57) ABSTRACT

A rotary electric machine includes a rotary shaft, a rotor provided on the rotary shaft, a stator and a housing. The stator includes a stator core, which is disposed on an outer periphery of the rotor, and a coil that is wound about the stator core and includes end coils exposed from the stator core in directions oriented along an axial direction of the rotary shaft. The housing, by which the rotary shaft is rotatably supported, accommodates the rotor and the stator in the interior thereof, and is provided with a housing flow pathway on an inner wall surface thereof. The housing flow pathway is serial and causes a liquid coolant for cooling an outer periphery of the stator core and the end coils to flow therethrough.

### CROSS-REFERENCE TO RELATED APPLICATIONS

This application is the U.S. National Phase of PCT International Application No. PCT/JP2016/081302, filed on Oct. 21, 2016. That application claims priority to Japanese Patent Application No. 2015-222735, filed Nov. 13, 2015. The contents of both applications are herein incorporated by reference in their entirety.

### BACKGROUND

### Technical Field

The present disclosure relates to a rotary electric machine, particularly to a rotary electric machine including a flow pathway for cooling.

### Background Information

Rotary electric machines have been used as power sources for hybrid cars, electric vehicles and so forth. The rotary electric machines are required to be cooled due to heat released therefrom in use. In a rotary electric machine described in Japan Laid-open Patent Application Publication No. 2014-107905, for instance, a rotor and a stator are disposed inside a housing, and a flow pathway for a liquid coolant is further provided in the housing. The flow pathway is provided in an upper part of the housing along the axial direction of a rotary shaft, and supplies the liquid coolant to the interior of the housing.

### BRIEF SUMMARY

In the rotary electric machine of Japan Laid-open Patent Application Publication No. 2014-107905, as described above, the flow pathway supplied with the liquid coolant is provided in the interior of the housing. Moreover, the liquid coolant is supplied to the outer periphery of the stator and a coil from the flow pathway through a plurality of ejection holes. In the configuration herein described, the liquid coolant is supplied to the outer periphery of the stator and the coil in a parallel manner from the flow pathway through the plural ejection holes. Hence, it is required to increase the total flow rate of the liquid coolant.

It is an object of the present disclosure to make it possible to efficiently cool a stator and a coil, with the flow rate of a liquid coolant being inhibited.

(1) A rotary electric machine according to the present disclosure includes a rotary shaft, a rotor provided on the rotary shaft, a stator and a housing. The stator includes a stator core, which is disposed on an outer periphery of the rotor, and a coil that is wound about the stator core and includes end coils exposed from the stator core in directions oriented along an axial direction of the rotary shaft. The housing, by which the rotary shaft is rotatably supported, accommodates the rotor and the stator in an interior thereof, and is provided with a housing flow pathway on an inner wall surface thereof. The housing flow pathway is serial and causes a liquid coolant for cooling an outer periphery of the stator core and the end coils to flow therethrough.

The stator core and the end coils are herein cooled through the serial housing flow pathway provided on the inner wall surface of the housing. In other words, the liquid coolant cools the stator core and the end coils by flowing through the housing flow pathway in a serial manner. Hence, compared to a well-known configuration to flow a liquid coolant in a parallel manner, the respective parts can be efficiently cooled will less liquid coolant.

(2) Preferably, the housing includes an inlet for flowing the liquid coolant into the housing flow pathway. Additionally, the liquid coolant is introduced into the housing flow pathway through the inlet, flows along the outer periphery of the stator core, and then flows toward the end coils.

When the temperature of the stator core and that of the end coils are herein considered, the temperature of the end coils becomes higher than that of the stator core. Therefore, when it is assumed that the liquid coolant is flown from each end coil side toward the stator core, the liquid coolant flows to the stator core after heated by each end coil. Hence, the stator core cannot be efficiently cooled.

In view of this, the liquid coolant is herein configured to be flown from the stator core with low temperature to each end coil with high temperature.

(3) Preferably, the rotary electric machine further includes a pair of covers that is disposed on both end parts of the housing in the axial direction of the rotary shaft so as to be opposed to the end coils and is integrated or separated from the housing. Moreover, a shaft end flow pathway is provided between an axial end surface of the stator core and each of the pair of covers so as to communicate with the housing flow pathway.

The liquid coolant is herein supplied to the shaft end flow pathway after flowing through the housing flow pathway. Then, the liquid coolant flows through the shaft end flow pathway, whereby the end coils can be efficiently cooled.

(4) Preferably, the housing includes an outlet for discharging the liquid coolant flowing thereto from the shaft end flow pathway to a drain.

(5) Preferably, the housing flow pathway includes an annular flow pathway and an axial flow pathway. The annular flow pathway is provided around an entire circumference of the inner wall surface of the housing. The axial flow pathway is provided on the inner wall surface of the housing, extends to outer peripheral sides of the end coils in the directions oriented along the axial direction of the rotary shaft, and communicates with the annular flow pathway.

(6) Preferably, the shaft end flow pathway communicates with the axial flow pathway.

In the present advancement as described above, the stator and the coil can be efficiently cooled, with the total flow rate of the liquid coolant being inhibited.

### BRIEF DESCRIPTION OF THE DRAWINGS

FIG. 1 is a vertical cross-sectional view of a rotary electric machine according to an exemplary embodiment of the present disclosure.

FIG. 2 is a front cross-sectional view of a housing of the rotary electric machine.

FIG. 3 is a perspective view of the appearance of the housing.

FIG. 4 is a front cross-sectional view of a housing according to another exemplary embodiment.

### DETAILED DESCRIPTION OF EMBODIMENTS

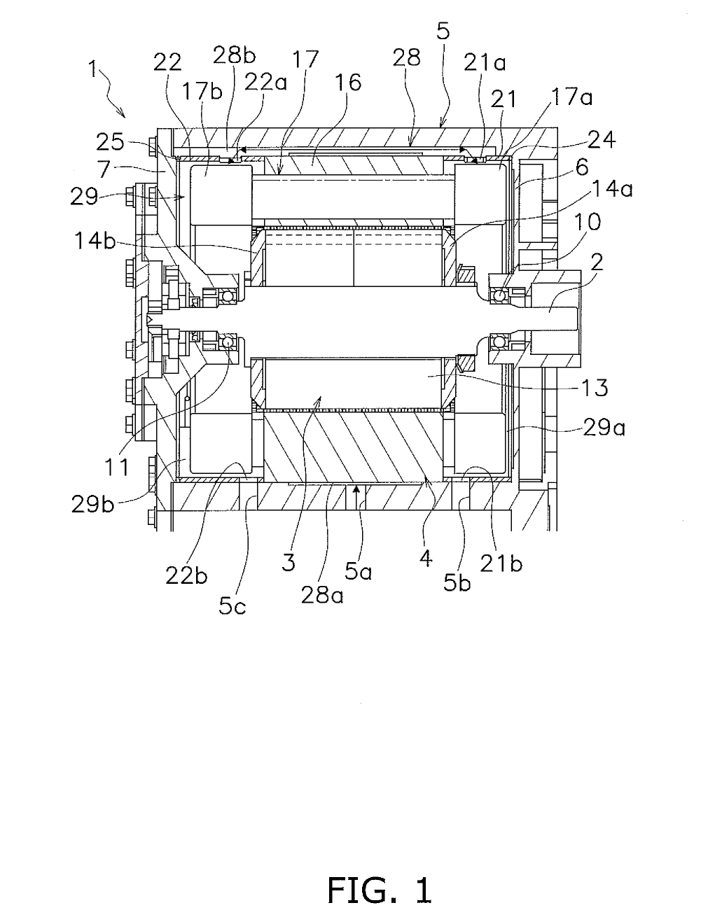

FIG. 1 shows a rotary electric machine 1 according to an exemplary embodiment of the present disclosure. FIG. 1 is a vertical cross-sectional view of the rotary electric machine 1. The rotary electric machine 1 includes a rotary shaft 2, a rotor 3 provided on the rotary shaft 2, a stator 4, a housing 5, a first cover 6 integrated with the housing 5, and a second cover 7 detachably attached to the housing 5.

[Device Configuration]

The rotary shaft 2 is rotatably supported at both ends thereof by the first cover 6 and the second cover 7 through bearings 10 and 11, and is thus supported by the housing 5.

The rotor 3 is attached to the rotary shaft 2, and includes a rotor core 13 and a pair of end plates 14a and 14b. The rotor core 13 is configured by laminating a plurality of magnetic plates along the axial direction of the rotary shaft 2. The pair of end plates 14a and 14b is attached to both axial ends of the rotor core 13, respectively.

The stator 4 includes a stator core 16 and a coil 17. The stator core 16 is formed by laminating a plurality of magnetic plates along the axial direction of the rotary shaft 2. The coil 17 is wound about the stator core 16, and has approximately the same length as the rotor core 13 in the axial direction. Additionally, the coil 17 includes end coils 17a and 17b exposed from the stator core 16 in directions oriented along the axial direction.

The housing 5 is made in the shape of a cylinder that includes the first cover 6 on one axial end side thereof and is also opened on the other axial end side thereof. Additionally, the second cover 7 is attached to the other end side. The rotor 3 and the stator 4 are accommodated in the interior of the housing 5.

A first sleeve 21 and a second sleeve 22 are disposed on the inner peripheral surfaces of both axial end parts of the housing 5. The first sleeve 21 is disposed between the first cover 6 and one end surface of the stator core 16 so as to be radially opposed to the end coil 17a. On the other hand, the second sleeve 22 is disposed between the second cover 7 and the other end surface of the stator core 16 so as to be radially opposed to the end coil 17b. It should be noted that each of the first and second sleeves 21 and 22 is made of an insulating material to insulate the housing 5 and each of the end coils 17a and 17b from each other.

A seal member 24 is disposed between the first cover 6 and one end surface of the first sleeve 21, whereas a seal member 25 is disposed between the second cover 7 and the second sleeve 22. It should be noted that although not provided in FIG. 1, seal members may be disposed between one end surface of the stator core 16 and the other end surface of the first sleeve 21 and between the other end surface of the stator core 16 and the other end surface of the second sleeve 22, respectively.

[Cooling Structure]

The present rotary electric machine 1 includes a cooling structure for mainly cooling the stator core 16 and the end coils 17a and 17b with a liquid coolant. The cooling structure includes a housing flow pathway 28, which is provided in the housing 5, and a shaft end flow pathway 29, which is provided between the housing 5 and the first and second covers 6 and 7.

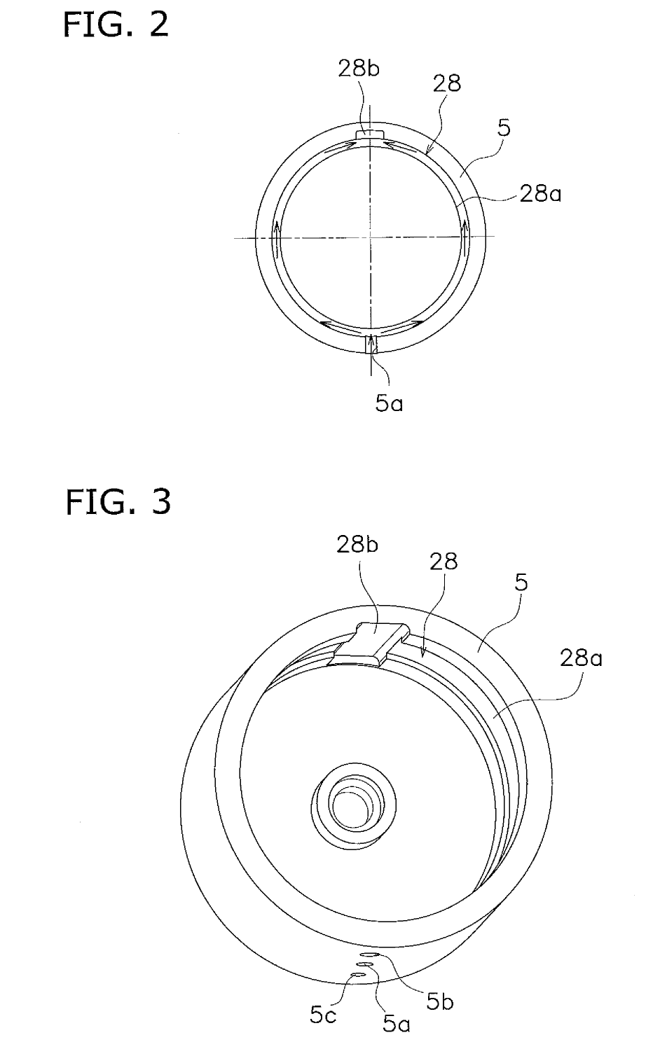

As shown in FIGS. 2 and 3, the housing flow pathway 28 includes an annular groove (annular flow pathway) 28a and an axial groove (axial flow pathway) 28b. It should be noted that FIG. 2 is a front cross-sectional view of the housing 5, whereas FIG. 3 is a perspective view of the appearance of the housing 5.

The annular groove 28a is provided around the entire circumference of the inner wall surface of the housing 5. The annular groove 28a is shorter than the stator core 16 in the axial direction, but has approximately the same length as the entire length of the stator core 16. Additionally, an inlet 5a is provided in the lower end part of the housing 5, and penetrates the housing 5 so as to communicate with the annular groove 28a.

The axial groove 28b is provided to extend in the axial direction. The axial groove 28b communicates with the annular groove 28a, and is provided to extend from the end part of the first cover 6 to the second cover 7. In other words, the axial groove 28b is provided to extend from the outer periphery of the first sleeve 21 to that of the second sleeve 22. Additionally, communication holes 21a and 22a are provided in the first and second sleeves 21 and 22, respectively, while radially penetrating therethrough so as to communicate with the axial groove 28b.

The shaft end flow pathway 29 includes a first shaft end flow pathway 29a on the first cover 6 side and a second shaft end flow pathway 29b on the second cover 7 side. The first shaft end flow pathway 29a communicates with the axial groove 28b of the housing flow pathway 28 through the communication hole 21a of the first sleeve 21. ON the other hand, the second shaft end flow pathway 29b communicates with the axial groove 28b of the housing flow pathway 28 through the communication hole 22a of the second sleeve 22.

The first shaft end flow pathway 29a is provided between the first cover 6 and one end surface (axial end surface) of the stator core 16. In other words, the first shaft end flow pathway 29a is provided to flow the liquid coolant to the axial end surface and outer peripheral part of the end coil 17a. On the other hand, the second shaft end flow pathway 29b is provided between the second cover 7 and the other end surface (axial end surface) of the stator core 16. In other words, the second shaft end flow pathway 29b is provided to flow the liquid coolant to the axial end surface and outer peripheral part of the end coil 17b.

Holes 21b and 22b are provided in the lower end parts of the first and second sleeves 21 and 22, respectively, while radially penetrating therethrough. Additionally, first and second outlets 5b and 5c are provided in the lower end part of the housing 5 so as to communicate with these holes 21b and 22b, respectively. These first and second outlets 5b and 5c are connected to a drain.

In the configuration described above, the outer periphery of the stator core 16 and one end coil 17a can be cooled by flowing the liquid coolant through a first serial flow pathway: the inlet 5a→the annular groove 28a→the axial groove 28b→the first shaft end flow pathway 29a→the first outlet 5b. On the other hand, the outer periphery of the stator core 16 and the other end coil 17b can be cooled by flowing the liquid coolant through a second serial flow pathway: the inlet 5a→the annular groove 28a→the axial groove 28b→the second shaft end flow pathway 29b→the second outlet 5c.

Here, the stator core 16 and each end coil 17a, 17b can be cooled by flowing the liquid coolant along each serial flow pathway. Therefore, compared to a well-known cooling configuration by flowing a liquid coolant in a parallel manner, it is possible to inhibit a flow rate necessary for a liquid coolant and compactly produce a pump for the liquid coolant.

Additionally, the liquid coolant is flown to the stator core 16, the temperature of which is relatively low, and is then flown to each end coil 17a, 17b, the temperature of which becomes higher than the stator core 16. Hence, it is possible to efficiently cool the stator core 16 and each end coil 17a, 17b.

### OTHER EXEMPLARY EMBODIMENTS

The present advancement is not limited to the exemplary embodiment described above, and a variety of changes or modifications can be made without departing from the scope of the present disclosure.

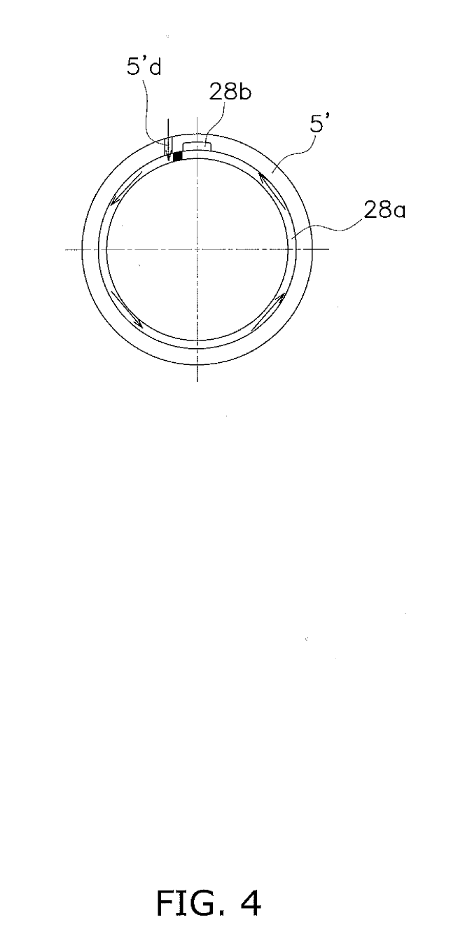

In the aforementioned exemplary embodiment, the inlet 5a for the liquid coolant is provided in the lower end part of the housing 5. However, as shown in FIG. 4, an inlet 5′d may be provided in the upper part of a housing 5′, and a liquid coolant may be configured to be flown in one direction along the annular groove 28a so as to be flown to the axial groove 28b.

### INDUSTRIAL APPLICABILITY

In a rotary electric machine of the present disclosure, a stator and a coil can be efficiently cooled, with the total flow rate of a liquid coolant being inhibited.

### REFERENCE SIGNS LIST

1 Rotary electric machine
2Rotary shaft
3 Rotor
4 Stator
5 Housing
5a Inlet
5b, 5c Outlet
6 First cover
7 Second cover
16 Stator core
17 Coil
17a, 17b End coil
28 Housing flow pathway
28a Annular groove (annular flow pathway)
28b Axial groove (axial flow pathway)
29 Shaft end flow pathway

1. A rotary electric machine comprising:
a rotary shaft;
a rotor provided on the rotary shaft;
a stator including a stator core and a coil, the stator core disposed on an outer periphery of the rotor, the coil being wound about the stator core, the coil including end coils, the end coils being exposed from the stator core in directions oriented along an axial direction of the rotary shaft; and
a housing by which the rotary shaft is rotatably supported, the housing accommodating the rotor and the stator in an interior thereof, the housing being provided with a housing flow pathway on an inner wall surface thereof, the housing flow pathway being serial, the housing flow pathway for causing a liquid coolant for cooling an outer periphery of the stator core and the end coils to flow therethrough.

2. The rotary electric machine according to claim 1, wherein
the housing includes an inlet for flowing the liquid coolant into the housing flow pathway, and
the liquid coolant is introduced into the housing flow pathway through the inlet, flows along the outer periphery of the stator core and then flows toward the end coils.

3. The rotary electric machine according to claim 1, further comprising:
a pair of covers disposed on both end parts of the housing in the axial direction of the rotary shaft so as to be opposed to the end coils, the pair of covers being integrated or separated from the housing, wherein
a shaft end flow pathway is provided between an axial end surface of the stator core and each of the pair of covers so as to communicate with the housing flow pathway.

4. The rotary electric machine according to claim 3, wherein the housing includes an outlet for discharging the liquid coolant that flows thereto from the shaft end flow pathway to a drain.

5. The rotary electric machine according to claim 3, wherein
the housing flow pathway includes
an annular flow pathway provided around an entire circumference of the inner wall surface of the housing, and
an axial flow pathway provided on the inner wall surface of the housing, the axial flow pathway extending to outer peripheral sides of the end coils in the directions oriented along the axial direction of the rotary shaft, the axial flow pathway for communicating with the annular flow pathway.

6. The rotary electric machine according to claim 5, wherein the shaft end flow pathway communicates with the axial flow pathway.
